(19) United States
(12) Patent Application Publication
(10) Pub. No.: US 2003/0225919 A1
(43) Pub. Date: Dec. 4, 2003

(54) Apparatuses for digital multimedia transmission with receiver requests

(76) Inventor: Christopher A. Dengler, Gilbert, AZ (US)

Correspondence Address: Parsons Behle & Latimer: Everett D. Robinson, Suite 1800, 201 South Main Street, Post Office Box 45898, Salt Lake City, UT, 84145-0898, US

(21) Appl. No.: 10/396,306

(22) Filed: Mar. 25, 2003

Related U.S. Application Data
(63) Continuation-in-part of application No. 09/422,159, filed on Oct. 22, 1999, now Pat. No. 6,581,103.

(51) Int. Cl. G06F 15/163; G06F 9/54; G06F 9/00

(52) U.S. Cl. 709/310

(57) ABSTRACT

Disclosed herein are server and client systems for interactive multimedia broadcasting over a network, and methods of using the same. Detailed information on various example embodiments of the inventions are provided in the Detailed Description below, and the inventions are defined by the appended claims.

### CROSS-REFERENCE TO RELATED APPLICATIONS

This application is a continuation-in-part of application Ser. No. 09/422,159, filed Oct. 22, 1999 which is hereby incorporated by reference in its entirety.

### BACKGROUND OF THE INVENTIONS

The broadcasting of audio and video by means of the Internet is a fairly recent development. When a listener logs onto a particular web site, audio files, usually songs, are played. The selections of which audio files are to be played are controlled by the owner or operator of the web site.

In the past, in conjunction with conventional radio, a desirable procedure was to get the listeners involved in conjunction with the broadcasting station. Generally, this type of procedure increased the number of listeners, and of course the greater number of listeners the more successful a radio station. One way to get the listeners involved is to have the radio station accept requests for particular songs or to hear certain audio files, such as a comedy routine. Generally, within conventional radio stations, requests are taken by telephone. It would be desirable to somehow incorporate in conjunction with an Internet radio station a technique for the Internet radio station to accept requests and dedications from listeners.

### BRIEF SUMMARY OF THE INVENTIONS

The inventions disclosed and claimed herein relate to the transmission of multimedia files and streams over networks and more particularly relate to systems that are capable of receiving the requests of users and providing multimedia files and streams over networks to computing devices in accordance with those user requests. Some systems in accordance with the invention permit users to make requests from their Internet Browsers or other client applications accessing the Internet and hear them over the Internet. In the past there haven't been Internet applications that allow for users to make real time requests for music or select audio songs, have them played back in an orderly fashion while allowing for the optional use of typed dedications to be spoken back over the audio stream. Detailed information on various example embodiments of the inventions are provided in the Detailed Description below, and the inventions are defined by the appended claims.

### BRIEF DESCRIPTION OF THE DRAWINGS

FIG. 1 shows a block diagram of the method of Internet radio broadcasting including listener requests and dedications of the present invention.

FIG. 2 shows a representation of a search screen that is to be displayed on a listener computer screen that allows for searching for a particular audio and/or video file.

FIG. 3 is a representation of a search results screen which is to be displayed on the listener computer screen and includes one section for the audio and/or video files available for final selection and another section for the optional input of a dedication.

FIG. 4 is a representation of an accepted screen, which is to be displayed on the listener computer screen.

Reference will now be made in detail to some embodiments of the inventions, example of which are illustrated in the accompanying drawings.

### DETAILED DESCRIPTION

One embodiment of the present invention relates to a method of Internet radio broadcasting including listener requests and dedications which comprises the following steps after a listener logs onto an Internet radio station. That embodiment then displays a search screen on the computer screen of the listener, which allows the listener to search for a particular audio and/or video. The listener then selects by the search screen a selected audio and/or video. The next step involves displaying on the computer screen of the listener a search results screen which displays one or more audio and/or videos which correspond to the audio and/or video search information inputted by the listener. The listener then selects a particular audio and/or video file in the search results screen. Also displayed on the search results screen is a dedication section allowing the listener to input a dedication to be spoken prior to the selected audio and/or video file. The listener inputs his/her dedication into this section. He/she may either type this dedication or upload his/her own voice. Then displayed on the computer screen is an accepted screen that informs the listener when the selected file is to be broadcasted with the accompanying dedication, if the dedication was made by the listener.

An alternate embodiment of the present invention is produced by modifying the previous embodiment by the audio and/or video file comprising a song. Another embodiment of the present invention is produced by broadcasting the dedication by using a text-to-speech engine. A further embodiment of the present invention is produced by the audio and/or video file comprising a song.

The invention encompasses an Internet technology and application technology to allow users of the Internet not only to search for musical artists or other audio and/or video files and select audio and/or video files for the Internet site to play back via streaming media, but also to type in dedications and statements from their browsers or other client applications connected to the Internet and have those statements broadcasted over the same stream via a text-to-voice speech engine just prior to playing the user's selected audio and/or video choice.

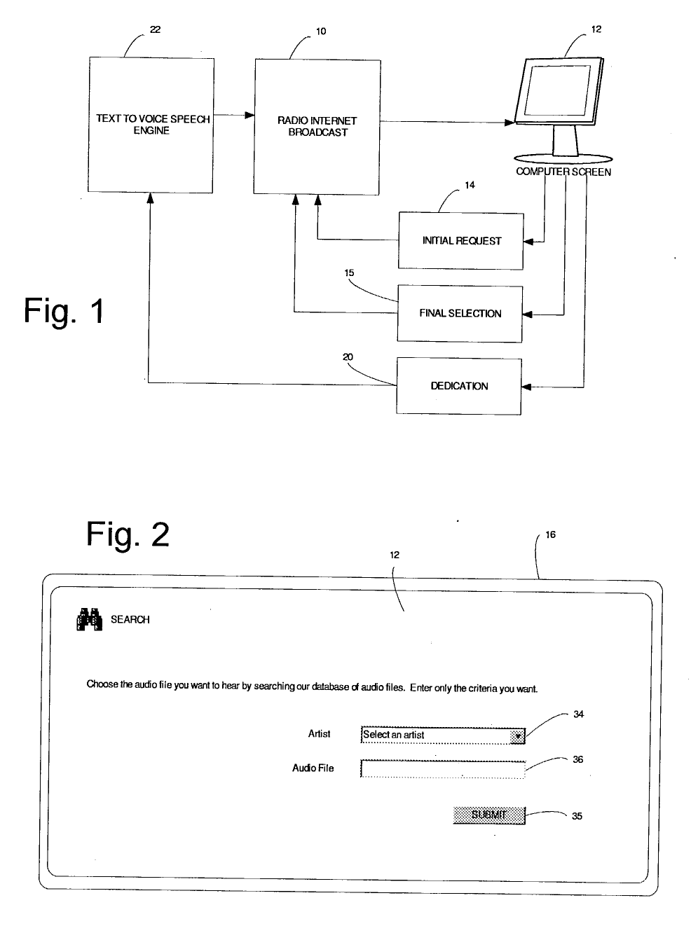

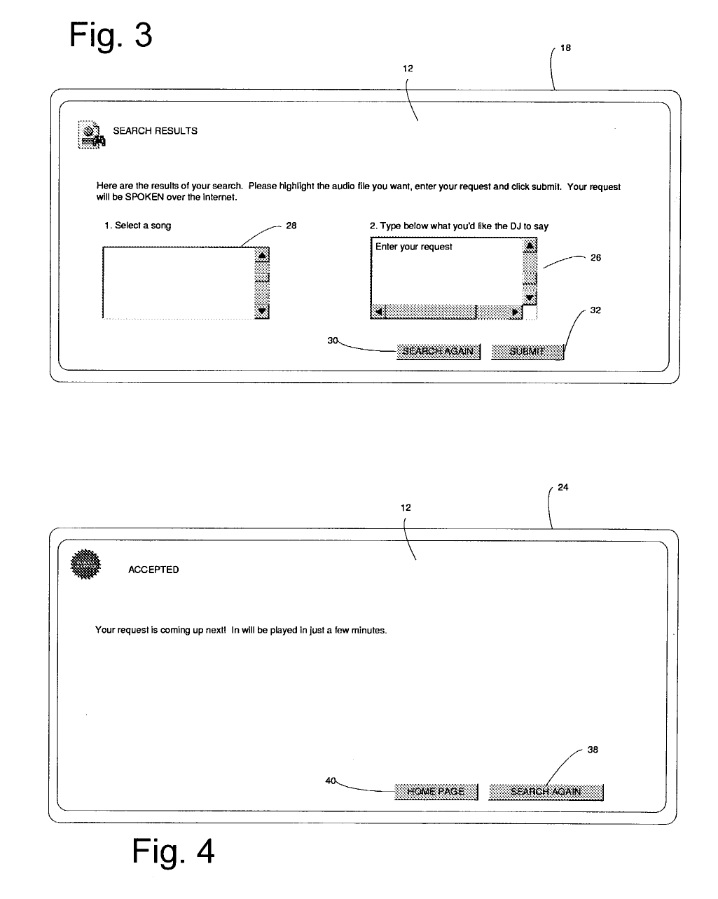

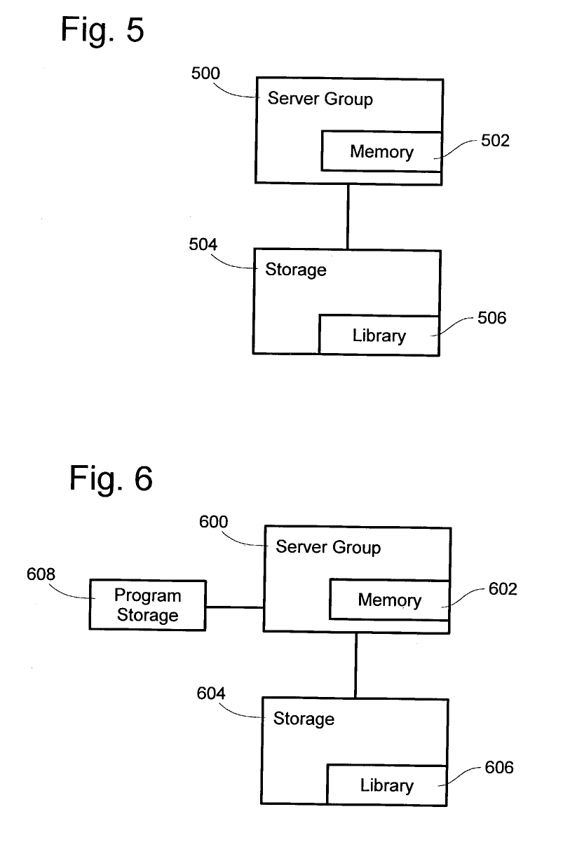

In one particular system of the invention, Radio is broadcasted over the Internet as is represented by box 10 in FIG. 1. The radio that is broadcasted by box 10 is broadcasted over the Internet to any computer that wants to log onto the web site for the radio Internet broadcast 10. The radio Internet broadcast 10 may be restricted to a particular regional geographical area or it may be countrywide or it may even be worldwide. A listener computer, which has a computer screen 12, can be logged onto the radio Internet broadcast 10. The listener computer can then make an initial request 14 by means of a search screen 16, which is shown in FIG. 2. Once an initial request has been input, this initial request is communicated back to the radio Internet broadcast 10. The listener will then have displayed a search results screen 18 also by means of the computer screen 12. This search results screen 18 is shown in FIG. 3. The final selection 15 is made by means of the search results screen 18. The search results screen 18 also has the option of creating a dedication 20. This dedication 20 is transmitted from the listener computer screen 12 to a text-to-speech engine 22 or upload of the user's voice file. The text-to-speech engine 22 or uploaded voice file is then coordinated with the radio broadcast 10 so upon playing of the final selection 15, the dedication 20 which has also been received by the radio Internet broadcast 10 will be played just prior to the final selection 15. This is done by taking the text that was input by the listener and reproducing it into computer generated spoken words by the text-to-speech engine 22, uploaded voice file, or spoken words by a live disc jockey. After the final selection 15 and the dedication 20 has been received by the radio Internet broadcast 10 and the text-to-speech engine 22, respectively, an accepted screen 24, FIG. 4, is shown on the listener computer screen 12. The associated dedication can then be emailed, for example, to the person it was dedicated to.

The radio Internet broadcast 10 has a library of audio and/or video files. Generally, these audio and/or video files will comprise of songs. However, other types of audio and/or video files could comprise comedic routines, dissertations, and so forth. The radio Internet broadcast 10 is programmed to play certain audio and/or video files in sequence. If there has not been an initial request 14, then that particular sequence will be followed. However, once a final selection 15 has been made, the final selection 15 will be given priority, that is, it will be played immediately following the currently playing audio and/or video file. If more than one selection that has been requested, as from multiple listeners, then each one of the final selections 15 will be played with the earliest accepted selection being played first (first in, first out basis).

Requests are audio and/or video files that are requested, such as songs. Dedications are the typed in or uploaded voice files that accompany requests. The dedication 20 is to be made by the listener typing on the listener's computer. The typing of the dedication 20 will be displayed in box 26 of the search results screen 18. The search results screen 18 will also display criteria that fit the initial request 14 in box 28 and allow for a final selection 15 to be submitted 32 with or without an accompanying dedication 20. For example, the listener may select a particular audio and/or video file. That audio and/or video file may be produced by ten different artists. The same audio and/or video file with the ten different artists will be displayed in box 28. The listener then has the option of selecting a specific artist and to highlight that section, and then by clicking the submit icon 32 the final selection 15 is transmitted to the radio Internet broadcast 10. After the dedication 20 has been typed in box 26, the listener is to click the submit icon 32 which will then cause the typed words of the dedication 20 to be transmitted to the text-to-speech engine 22. The text-to-speech engine 22, uploaded voice file, or spoken words by a live disc jockey will then be broadcasted with the final selection 15 which has been transmitted to the radio Internet broadcast 10 so that when the final selection 15 is played, the dedication 20 in speech form, will be transmitted prior to broadcasting of the final selection 15.

The search screen 16 includes an artist selection block 34. The search screen 16 also includes audio and/or video file input block 36. If the listener makes a selection within the artist block 34 and inputs particular audio and/or video search criteria in block 36, then more than likely there will only be a single selection that will be reproduced within the block 28. However, if the listener only inputs a particular audio and/or video search criteria in block 36 and does not make an artist selection, then more than likely there will be multiple selections that will be reproduced in the block 28 from which the listener may select one. The same will also be true if the listener only selects a particular artist from block 34 but does not input any particular audio and/or video search criteria within block 36. The search will be initiated upon the listener pressing the submit 35 icon.

The accepted screen 24 will display information about when your particular selection will be displayed. It will tell you if there are audio and/or video files that are ahead of you, and how many of these audio and/or video files are to be played prior to your audio and/or video file being played. The accepted screen 24 also includes a search again icon 38 and a home page icon 40. Pressing of the home page icon 40 will bring the listener back to the first or home page of the web site. Pressing of the search again icon 38 will bring screen 16 up on the computer screen. When the listener makes a selection, the Internet site that contains the radio Internet broadcast 10 then searches a database, comprising of a programming interface for database access. This programming interface is based on the call-level interface specification from X/open and ISO/IE for database application programming interfacing and uses a structured query language as its database access language.

It is to be understood that most any device with Internet access could be used, whether it's a portable computer, desktop unit, or handheld device. The computer may or may not include a monitor, but of course, all computers do include a display screen. It is within the display screen that there will be displayed the screens 16, 18, and 24.

When the radio Internet broadcast 10 finds a song or other audio and/or video file in the request queue, it checks to see if there is any text dedication announcement or any other type of typed in statement stored with this audio and/or video file. If there is, then the radio Internet broadcast 10 calls on the text-to-speech engine 22, updated voice file, or spoken words by a live disc jockey to verbally reproduce the dedication entered by the listener and then plays the selected audio and/or video file. Of course, the text will be verbally broadcast prior to the playing of the particular audio and/or video file. If there isn't any dedication 20, then just the final selection 15 audio and/or video file will be played. All audio and/or video files are broadcasted by the radio Internet broadcast 10 over the Internet by way of streaming audio and/or video, which means that it is continuous.

It will be apparent from the discussion above that a system of the invention that performs methods of the invention may be constructed as illustrated in FIG. 5. A server group 500 contains one or more servers having network hardware and software for communication to a network. Server group is accessibly connected to a storage device 504 whereon a library of files 506 containing digitally encoded audio and/or video information. Memory 502 accessible to server group 500 is used to store and maintain information related to requests received from a network connected to the server.

FIG. 6 depicts a server system also apparent from the above discussion. A server group 600 contains one or more servers having network hardware and software for communication to a network. Server group is accessibly connected to a storage device 604 whereon a library of files 606 containing digitally encoded audio and/or video information. Server group is also accessibly connected to a program storage device 608 whereon is stored software necessary to distribute or broadcast files or streams of content contained in the library of files 606. Memory 602 accessible to server group 600 is used to store and maintain information related to requests received from a network connected to the server.

While the present devices and methods have been described and illustrated in conjunction with a number of specific configurations, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

What is claimed:

1. A computer network system for transmission of digital multimedia over a network, the system having provision to accept requests from receivers for the selection of transmitted content, the system comprising:
network connection facilities for electronic connection to a computer network;
communication facilities for digital communication to and from clients on the network through said network connection facilities;
library access facilities, said library access facilities including a facility for retreiving multimedia selections from a library of digital multimedia files, said library access facilities further including a facility for retrieving directories of multimedia files in the library;
memory data structure facilities for maintaining a memory data structure containing request information from received requests, the request information suitable to identify at least one selection from the library;
request reception facilities for receiving requests from listeners using clients on the network, the receiving performed through the use of said communication facilities, said request reception facilities further having the capability of placing request information of received requests into the memory data structure;
selection facilities for reading the request information contained in the memory data structure, said selection facilities further being capable of selecting files from the library using said library access facilities, said selection facilities selecting files identified by the request information read from the memory data structure;
and transmission facilities for transmitting digital multimedia selections contained in the library to clients on the network by said communication facilities.

2. The computer network system of claim 1, wherein:
said library access facilities also include a facility for searching the library using search information, the searching producing search results;
and said computer network system further comprises:
(i) a search query reception facility for receiving search queries from clients on the network, the search queries containing search information;
(ii) a search results transmission facility for transmitting a search results screen to clients on the network, the search results screen containing search results produced by said library access facilities.

3. A server system for transmission of digital multimedia over a network, the system having provision to accept requests from receivers for the selection of transmitted content, the system comprising:
a server group comprising at least one server, each of said servers having network software and network hardware by which said servers are electronically connectable to communicate over a computer network with a plurality of client computing devices;
memory accessible by said servers;
at least one library storage device accessible to at least one of said servers, said library storage device having contained thereon a library of files containing at least digitally encoded audio signals;
at least one program storage device accessible by said processor system, said program storage device not necessarily being distinct from said library storage devices, said program storage device further computer instructions executable by said processor system to achieve the functions of:
(i) receiving listener requests for selections from client computing devices through said network hardware, network software and a network connection of said servers, each request containing request information sufficient to identify at least one selection,
(ii) producing reference information suitable to identify at least one selection in said library using the request information,
(iii) maintaining a memory data structure in said memory suitable to contain a plurality of listener request records, each listener request record containing either request information or reference information,
(iv) placing a request record into the data structure for later retrieval, the request record containing either the request information of the received requests or the produced reference information,
(v) at repeated times, examining the memory data structure for the presense of a listener request record,
(vi) after detecting the presense of a listener request record in said examining, choosing a request record from the memory data structure,
(vii) after said choosing, identifying at least one selection in said library using the information contained in the chosen request record,
and (viii) after said identifying, transmitting the identified selection to the plurality of client computing devices through said network hardware, network software and a network connection of said servers.

4. A server system according to claim 3, wherein said computer instructions are further executable to perform the functions of:
(ix) receiving a search query from a client computing device through said network hardware and network software,
(x) searching of said library using the search queries, said searching producing search results containing references of files in the library,
and (xi) transmitting the search results to the client computing device from which the search query was received through said network hardware and network software.

5. A server system according to claim 3, wherein said computer instructions are further executable to perform the functions of:
(ix) transmitting a search screen to a client computing device through said network hardware and network software,
(x) receiving a search query from the client computing device to which the search screen was sent through said network hardware and network software,
(xi) searching said library using the search queries, said searching producing search results containing references of files in the library,
and (xii) transmitting the search results to the client computing device from which the search query was received through said network hardware and network software.

6. A server system according to claim 5, wherein:
the search screen transmitted to a client computing device contains an entry field for an artist identifier;
the receiving a search query function of the computer instructions is capable of receiving an artist identifer;
and the searching function of the computer instructions is capable of searching utilizing an artist identifer contained in a search query.

7. A server system according to claim 3, wherein said computer instructions are further executable to perform the functions of:
(ix) transmitting a search screen to a client computing device through said network hardware and network software,
(x) receiving a search query from the client computing device to which the search screen was sent through said network hardware and network software,
(xi) searching said library using the search queries, said searching producing search results containing references of files in the library,
and (xii) transmitting a search results screen to the client computing device from which the search query was received through said network hardware and network software, the search results screen including references from the search results.

8. A server system according to claim 3, wherein said network hardware and network software of said servers are electronically connectable to communicate with the Internet.

9. A server system according to claim 3, wherein the functions of the computer instructions prioritizes the choosing of request records in chronological order of reception.

10. A set of computer readable media according to claim 3, wherein the the memory data structure maintained by said computer instructions is a FIFO structure.

11. A set of computer readable media containing computer executable instructions for operation of a digital multimedia network system, the set of computer readable media comprising at least one medium upon which is stored computer instructions executable by a computing system containing memory to achieve the functions of:
(i) receiving listener requests for selections from client computing devices, said receiving being performed by the computing system through network software and network hardware included in the computing system, each listener request containing request information sufficient to identify at least one selection,
(ii) producing, using the request information, reference information suitable to identify at least one selection in a library of files, the files containing at least digitally encoded audio signals,
(iii) maintaining a memory data structure in the memory suitable to contain a plurality of listener request records, each listener request record containing either request information or reference information,
(iv) placing either the request information of requests or the produced reference information into the data structure for later retrieval,
(v) at repeated times, examining the memory data structure for the presense of a listener request record,
(vi) after detecting the presense of a listener request record in said examining, choosing a request record from the memory data structure,
(vii) after said choosing, identifying at least one selection in the library using the information contained in the chosen request record,
and (viii) after said identifying, transmitting the identified selection to the plurality of client computing devices through the network software and network hardware included in the computing system.

12. A set of computer readable media according to claim 11, wherein said computer instructions are further executable to perform the functions of:
(ix) receiving a search query from a client computing device through the network software and network hardware included in the computing system,
(x) searching the library using the search queries, said searching producing search results containing references of files in the library,
and (xi) transmitting the search results to the client computing device from which the search query was received through the network software and network hardware included in the computing system.

13. A set of computer readable media according according to claim 11, wherein said computer instructions are further executable to perform the functions of:
(ix) transmitting a search screen to a client computing device through the network software and network hardware included in the computing system,
(x) receiving a search query from the client computing device to which the search screen was sent through the network software and network hardware included in the computing system,
(xi) searching of said library using the search queries, said searching producing search results containing references of files in the library,
and (xii) transmitting the search results to the client computing device from which the search query was received through the network software and network hardware included in the computing system.

14. A set of computer readable media according according to claim 13, wherein:
the search screen transmitted to a client computing device contains an entry field for an artist identifier;
said receiving a search query function of the computer instructions is capable of receiving an artist identifer;
and said searching function of the computer instructions is capable of searching utilizing an artist identifer contained in a search query.

15. A set of computer readable media according according to claim 11, wherein said computer instructions are further executable to perform the functions of:
(ix) transmitting a search screen to a client computing device through the network software and network hardware included in the computing system,
(x) receiving a search query from the client computing device to which the search screen was sent through the network software and network hardware included in the computing system,
(xi) searching the library using the search queries, said searching producing search results containing references of files in the library,
and (xii) transmitting a search results screen to the client computing device from which the search query was received through the network software and network hardware included in the computing system, the search results screen containing references from the search results.

16. A set of computer readable media according according to claim 11, wherein said network hardware and network software of said servers are electronically connectable to communicate with the Internet.

17. A set of computer readable media according according to claim 11, wherein the functions of the computer instructions prioritizes the choosing of request records in chronological order of reception.

18. A set of computer readable media according to claim 11, wherein the the memory data structure maintained by said computer instructions is a FIFO structure.
